(19) United States
(12) Patent Application Publication
(10) Pub. No.: US 2001/0028404 A1
(43) Pub. Date: Oct. 11, 2001

(54) Signal pocessing method, picture encoding apparatus and picture decoding apparatus

(76) Inventors: Takahiro Fukuhara, Kanagawa (JP); Seiji Kimura, Chiba (JP)

Correspondence Address: William S. Frommer, Esq., FROMMER LAWRENCE & HAUG LLP, 745 Fifth Avenue, New York, NY, 10151, US

(21) Appl. No.: 09/801,290

(22) Filed: Mar. 7, 2001

(30) Foreign Application Priority Data
Mar. 8, 2000 (JP) 2000-068657

(51) Int. Cl. H04N 7/12; H04N 11/02; H04N 11/04

(52) U.S. Cl. 348/384.1

(57) ABSTRACT

Picture encoding based on a file format and the syntax for Motion-JPEG2000 standard derived from the syntax of the JPEG2000 standard as a basis is to be realized. One or more pictures are input to an encoding unit 20 for encoding in accordance with the JPEG2000 standard. A picture-based encoded bitstream, obtained on encoding by the encoding unit 20, is sent to an output bitstream generating unit 26. The output bitstream generating unit 26 sequentially couples picture-based encoded bitstreams, appends a variety of codes for implementing a syntax prescribed in the encoding standard to the encoded bitstreams, and embeds at least one of the picture number required in encoding the plural pictures, encoding picture rate, and the frame/field encoding mode information, for the case of the picture being an interlaced picture, in vacant bits of the prescribed codes.

### BACKGROUND OF THE INVENTION

1. Field of the Invention

This invention relates to a signal processing method, picture encoding apparatus and picture decoding apparatus for encoding a still picture, continuous still pictures and moving pictures for conversion into an output bitstream.

2. Description of Related Art

Typical of a conventional picture compression system is the encoding system of the JPEG (Joint Photographic Coding Experts Group) standardized by the ISO (International Organization for Standardization). The encoding by this JPEG system is used for compressing and encoding mainly a still picture using DCT (discrete cosine transform). This system is known to furnish optimum encoded and decoded pictures if a larger number of bits are allocated.

The ISO is now preparing the JPEG2000 standard, to take the place of the aforementioned JPEG standard, as the next-generation international standard for still pictures. In this JPEG2000, the JPEG2000 Part-1 is a standard for implementing a decoder of the minimum structure of a still picture, while the JPEG2000 Part-1 is now being prepared as a standard pertinent to a decoder for continuous still pictures or moving pictures derived from the JPEG2000 Part-1 as a basis.

At present, the MPEG (Moving Picture Experts Group)-2 standard and the DV (Digital Video) standard are most popular as the compression format for moving pictures. The former is used for compressing DVD pictures, whilst the latter, also called the DVC standard, is used as a compression format for digital video cameras or movies for household use. In these formats, file formats or data structures are sometimes prescribed for recording on an optical disc or on a tape medium. For example, the DV standard uses a compression format and a data structure, which are in keeping with a tape medium, for recording on the tape medium, with the exception of a broadcast editing equipment for professional use, such as a non-linear editing equipment.

Although not standardized by the ISO, there is also a moving picture compression technique, termed the Motion-JPEG standard, as the de-facto standard. This compresses each one of plural still pictures in accordance with the encoding system of the JPEG standard, and may be thought of as an extension of still picture encoding rather than the moving picture encoding. The encoding system of the Motion-JPEG standard is actually used in capturing moving pictures of the PC extension board, moving pictures codec of a digital still camera and the non-linear editing equipment.

Similarly to this Motion-JPEG, the JPEG2000 Part-3, also colloquially termed Motion-JPEG2000, now being prepared for standardization, compresses plural pictures by means provided in the JPEG2000 Part-1. The technique for encoding a set of continuous pictures, namely moving and still pictures, are expected to be used in a variety of applications, such as codec (coder-decoder) for continuous still pictures by an electronic still camera, video movie, portable and mobile picture transmission/reception terminal (PDA), companders for high-definition pictures, such as satellite pictures or pictures for medical use, digital mapping, slide show, database or software modules thereof.

Meanwhile, the Motion-JPEG standard, as the aforementioned de-facto standard, is not standardized by the ISO as the organization, there being plural standards in a somewhat disorderly fashion, thus obstructing its acceptance at large. In this consideration, standardization of the Motion-JPEG standard by an official organization may be said to be crucial for further development of the related industrial circles.

However, simple junction of picture units of the JPEG2000 standard for still pictures of the baseline system is not sufficient to cope with numerous applications, such as those described above.

### SUMMARY OF THE INVENTION

It is therefore an object of the present invention to provide a signal processing method, a picture encoding apparatus and a picture decoding apparatus capable of readily coping with a variety of applications of encoding a consecutive set of moving or still pictures, based on the syntax for the Motion-JPEG2000 standard derived from the syntax of the JPEG2000 standard and on the file format.

In one aspect, the present invention provides a signal processing method including a picture inputting step of inputting one or more pictures, an encoding step of encoding the pictures in accordance with a pre-set encoding standard from one picture to another, a step of sequentially coupling picture-based encoded bitstreams, a code appending step of appending a variety of codes for implementing a syntax prescribed in the encoding standard to the encoded bitstreams and an embedding step of embedding at least one of the picture number required in encoding the plural pictures, encoding picture rate, and the frame/field encoding mode information for the case of the picture being an interlaced picture, in vacant bits of the prescribed codes.

The pre-set encoding standard may be the JPEG2000 standard and at least one of the picture number required in encoding the plural pictures, encoding picture rate and the frame/field encoding mode information may be embedded in vacant bits of Rsiz or CSSiz in SIZ parameters in the syntax of the JPEG2000 standard.

In this encoding, a sole picture is encoded in accordance with the routine JPEG2000 standard for still pictures to output a bitstream. In appending the various codes for implementing the syntax prescribed in the JPEG2000 standard, those already prescribed in the JPEG2000 standard are directly used. One of the picture number which becomes necessary in encoding the interlaced picture, encoding picture rate and the frame/field encoding mode information, for a case of the input picture being an interlaced picture, is embedded in vacant bits of the codes prescribed in the JPEG2000 standard.

In another aspect, the present invention provides a signal processing method including a step of being fed with an output bitstream, the output bitstream being a bitstream obtained on encoding input pictures in accordance with a pre-set encoding standard per picture of the input pictures, the bitstream obtained on encoding input pictures having embedded in a header part thereof a variety of codes for realizing a syntax prescribed in the encoding standard and an integer value obtained on dividing an original picture number by a value of the display picture rate, and deciphering the codes in the header part of the output bitstream to detect a number from 0 to the value of the display picture rate, a step of multiplying an integer obtained on dividing the original picture number by the value of the display picture rate with the value of the display picture rate, and a step of computing an ultimate picture number from the multiplied result and the detected number.

In a further aspect, the present invention provides a signal processing method including a step of being fed with an output bitstream, the output bitstream being a bitstream obtained on encoding input pictures in accordance with a JPEG2000 standard per picture of the input pictures, the bitstream obtained on encoding input pictures having embedded in a header part thereof a variety of codes for realizing a syntax prescribed in the JPEG2000 standard and an integer value obtained on dividing an original picture number by a value of the display picture rate, and deciphering the codes in the header part of the output bitstream to detect a number from 0 to the value of the display picture rate, a step of changing a Signature box, as one of boxes of a file format prescribed in the JPEG2000 standard, into a Signature box extended for moving pictures, and a step of adding a picture number to a picture-based encoded bitstream for continuous plural pictures, there being provided one of the total number of encoded pictures, encoding picture rate, and the Box of the frame/field encoding mode information for the case of the picture being an interlaced picture.

According to the present invention, in which one or more pictures is fed as input pictures, the input pictures are encoded in accordance with a pre-set encoding standard from one picture to another, picture-based encoded bitstreams are coupled together sequentially, a variety of codes for implementing a syntax prescribed in the encoding standard are appended to the encoded bitstreams, and at least one of the picture number required in encoding the plural pictures, encoding picture rate, and in which the frame/field encoding mode information, for the case of the picture being an interlaced picture, is embedded in vacant bits of the prescribed codes, a set of consecutive moving or still pictures can be encoded to enable the facilitated application to a codec of consecutive still pictures photographed by an electronic still camera a video movie, video movie, portable and mobile picture transmission/reception terminals (PDA), compression and decompression units for high definition pictures, such as satellite pictures or pictures for medical use, digital mapping, slide show, database or software modules thereof.

By using the JPEG2000 standard as the pre-set encoding standard, and by stating the indispensable information ancillary to a collection of plural still pictures or an encoded bitstream of moving pictures, such as encoding picture rate or frame/field encoding mode in vacant bits of codes defined in the syntax prescribed in the JPEG2000 standard, the encoded bitstream of the Motion- JPEG2000 standard as the standard for the moving pictures can be stated as the compatibility with respect to the JPEG2000 standard is maintained.

Since there is provided means for adaptively varying the frame/field mode from one tile part to another, encoding control exploiting tile-based local properties is possible even in case of tile-based encoding in accordance with the JPEG2000 standard, thus enabling high picture quality to be maintained.

By the file format of the Motion- JPEG2000 standard, extended from the file format of the JPEG2000 standard as a basis, it becomes possible to state encoding conditions or parameters not possible with the file format of the JPEG2000 standard dedicated to still pictures.

### BRIEF DESCRIPTION OF THE DRAWINGS

FIG. 1 is a block diagram showing a schematic structure of a picture encoding apparatus according to a first embodiment of the present invention.

FIG. 2 shows a structure of an encoded bitstream prescribed as a syntax of the JPEG2000 standard.

FIG. 3 shows a structure of a main header prescribed as a syntax of the JPEG2000 standard.

FIG. 4 shows a structure of a tile header (tile-part header) prescribed as a syntax of the JPEG2000 standard.

FIG. 5 illustrates a header structure of consecutive pictures of an encoded bitstream.

FIG. 6 illustrates the structure of a parameter Scod of an encoded bitstream prescribed as a syntax of the JPEG2000 standard.

FIG. 7 illustrates the structure of a parameter Scod of the Motion-JPEG2000 standard as extension of the JPEG2000 standard for moving pictures.

FIG. 8 illustrates a file structure prescribed in a file format of the JPEG2000 standard.

FIG. 9 illustrates a file structure of the Motion-JPEG2000 standard Scod as extension of the JPEG2000 standard for moving pictures.

FIG. 10 illustrates a typical application of digital mapping.

FIG. 11 illustrates a typical application of a slide show.

FIG. 12 illustrates a typical application of a database for personal information.

### DESCRIPTION OF THE PREFERRED EMBODIMENTS

Referring to the drawings, preferred embodiments of a signal processing method and a picture encoding apparatus based on the syntax for the Motion-JPEG2000 as extension of the JPEG2000 standard for moving pictures (rules on the grammar of encoded data and rules for data sequences) and on the file format, according to the present invention, will be explained in detail.

### First Embodiment

A first embodiment of the present invention includes a picture inputting step of inputting one or more pictures, an encoding step of encoding the pictures in accordance with a pre-set encoding standard from one picture to another, a step of sequentially coupling picture-based encoded bitstreams, a code appending step of appending a variety of codes for implementing a syntax prescribed in the encoding standard to the encoded bitstreams and an embedding step of embedding at least one of the picture number required in encoding the plural pictures, encoding picture rate, and the frame/field encoding mode information, in vacant bits of the prescribed codes, for the case of the picture being an interlaced picture.

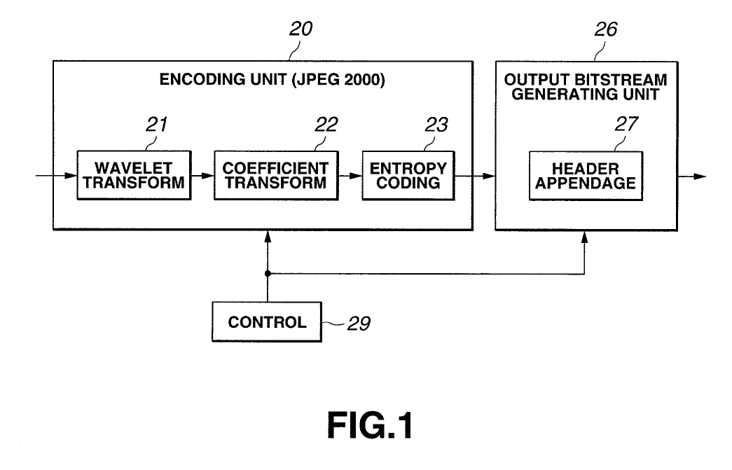

FIG. 1 shows a picture encoding apparatus to which the signal processing method embodying the present invention is applied. In FIG. 1, an encoding unit 20 is fed with one or more pictures, which then are encoded in accordance with e.g., the JPEG2000 standard, as a pre-set encoding standard. This encoding unit 20 is made up of a wavelet transform unit 21 fed with one or more pictures, a coefficient quantizing unit 22 for quantizing the wavelet transform coefficients from the wavelet transform unit 21 and an entropy encoding unit 23 for entropy encoding the quantization coefficients from the quantizer 22. The picture-based encoded bitstream, obtained on encoding by the encoding unit 20, is sent to an output bitstream generating unit 26, which then connects the above-mentioned picture-based encoded bitstreams together sequentially, appends to the encoded bitstream variable codes for realizing the syntax as prescribed in the JPEG2000 standard as the above-mentioned encoding standard, and embeds at least one of the picture number as required in encoding the plural pictures, encoded picture rate and the frame/field encoding mode information in case the picture is an interlaced picture, in vacant bits of the prescribed codes. This output bitstream generating unit 26 includes a header appending unit 27 for appending a header to the encoded bitstream. The operations of the encoding unit 20 and the output bitstream generating unit 26 are controlled in operation by a controller 29.

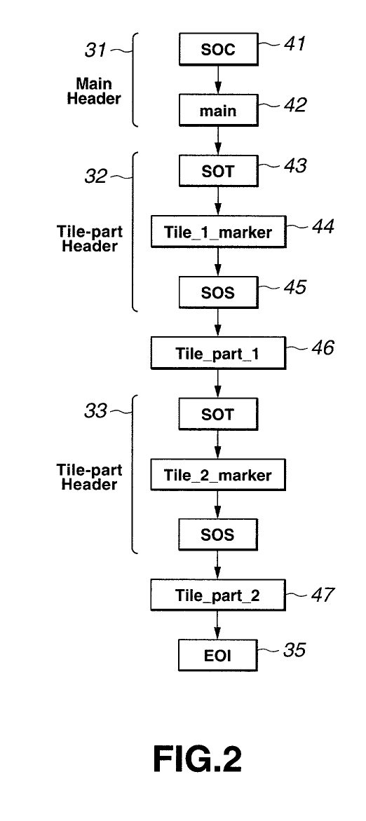

The syntax stating the encoding sequence stated in the Committee Draft (CD) of the JPEG2000 Part-1 (rules on the grammar of encoded data and rules for data strings) is now explained. FIGS. 2, 3 and 4 show the structure of the encoded bitstream, the structure of a main header and the structure of a tile header (Tile-part Header), respectively.

The JPEG2000 standards provide for means for splitting a picture being encoded into tiles of an optional size to effect encoding from one tile to another. To this end, the JPEG2000 standards provide for plural sets, namely a main header 31, a tile header (tile-part header) 32 and a tile part (tile_part) 46, as shown in FIG. 2. Although one more set of the tile header (tile-part header) 33 and a tile part (Tile_part) 47 are shown in FIG. 2, for simplicity, it is similarly possible to increase the number of sets.

The main header 31 includes a code SOC (Start of Codestream) 41 and a main header marker segment (main) 42. The tile header (Tile-part Header) 32 includes a code SOT (Start of Tile-parts) 44, a tile header marker segment (Tile-marker) 44 and a code SOS (Start of Data) 45. Next to the code SOS 45 at the trailing end of the tile header (Tile-part Header) 32 is arrayed a tile part (Tile_part) as a tile base encoded data.

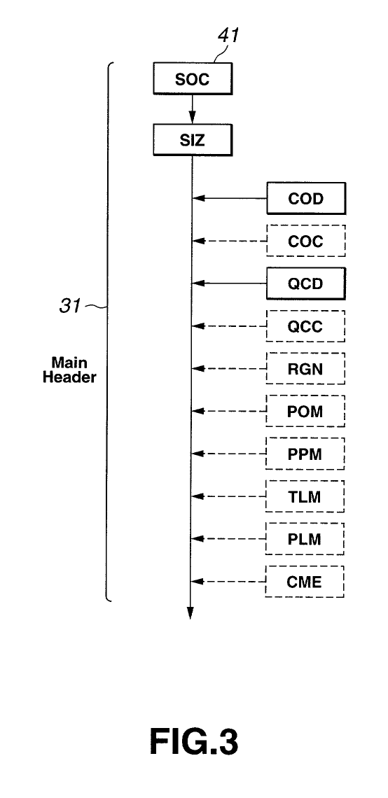

FIG. 3 shows a structure of a main header 31. At the leading end of the bitstream is arrayed a code SOC (Start of Codestream) 41. By this SOC, the start position of the bitstream of the JPEG2000 standard can be discriminated. The next code SIZ (Image and Tile Size), also used as a second marker, states the information pertinent to the offset value of a picture area, number of components and the size such as pit width. The code COD (Coding Style Default) includes statement pertinent to encoding means, such as number of wavelet splitting stages, Code-Block size, or transform filters. The code COC (Coding Style Component) is of the same contents as the COD, however, it has plural components in which statement is to be made when doing respective separate designations. The code QCD (Quantization default) comprehends markers, quantization means and quantization step size values. The code QCC (Quantization component) is of the same contents as the COD, however, it has plural components in which statement is to be made when doing respective separate designations. The code RGN (Region of Interest) includes the information of the marker, marker length of a region of interest ROI in a picture and the style of the ROI. The code POM (Progression Order Change (main)) includes the description of the contents specifying changes of the progressive sequence in the main header. The code PPM (Packed Packet Headers (main)) is a collection of several packet headers of the main header. The code TLM (Title-parts Lengths (main)) includes the information such as markers, numbers of tiles to which belong the Tile-parts, the positions of the Tile-parts and so forth. The code PLM (Packet length (main)) includes the information in the main header on the marker and on the packet length of the Tile-parts. The code CME (Comment and Extension) is provided for future extension such as insertion of comments. Of these codes, the codes SOC, SIZ, COD and QCD indicated by solid-line frames are essential, while the codes COC, QCC, RGN, POM, PPM, TLM, PLM and CME, indicated by broken-line frames, are subordinate or optional.

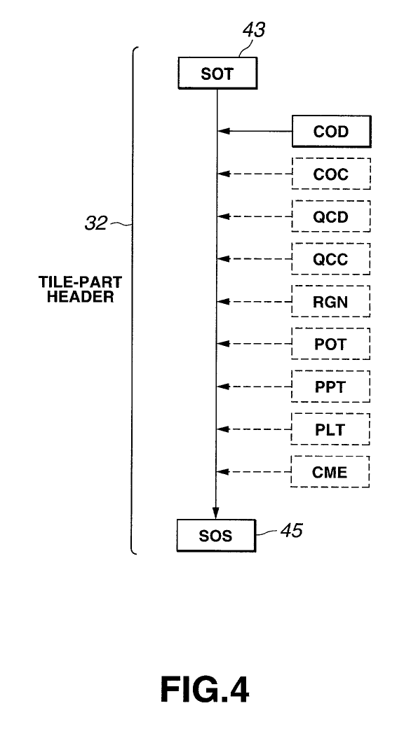

FIG. 4 shows a structure of a tile header (Tile-part Header) 32, at the leading end of which is arrayed a code SOT (Start of Title-parts) 41. This code SOT is positioned at the leading end of the Tile-parts header and includes the number or a marker of a tile of which the Tile-parts is a part. At the trailing end of the tile header (Tile-part Header) 32 is arrayed a code SOS (Start of Data) 45 specifying the trailing end of the Tile-parts Header, that is the beginning position of the tile encoded data. Next to the leading end code SOT is arrayed the aforementioned code COD (Coding Style Default). This code COD comprehends the description pertinent to the aforementioned encoding means. These codes SOT, COD and SOS are indispensable codes. Between the codes COD and SOS are arrayed codes COC, QCD, QCC, RGN, POT, PPT, PLT and CME as necessary. Since the codes COC, QCD, QCC, RGN and CME are similar to the respective codes in the aforementioned main header (Main Header), the codes POT, PPT and PLT are here explained. The code POT (Progression Order Change (tile-parts)) comprehends the description of the contents specifying changes in the progressive order in the tile of the tile header. The code PPT (Packed Packet Headers (tile-parts)) is a collection of several Packet headers in the tile header. The code PLT (Packet Length (tile-part)) comprehends the information in the tile header which is pertinent to the marker and to the packet length of the Tile-parts. Meanwhile, the encoded bitstream of the Tile_Parts, as it is so termed here, is generated on splitting an encoded bitstream of a tile, of which the Tile-part is a part, into several packets.

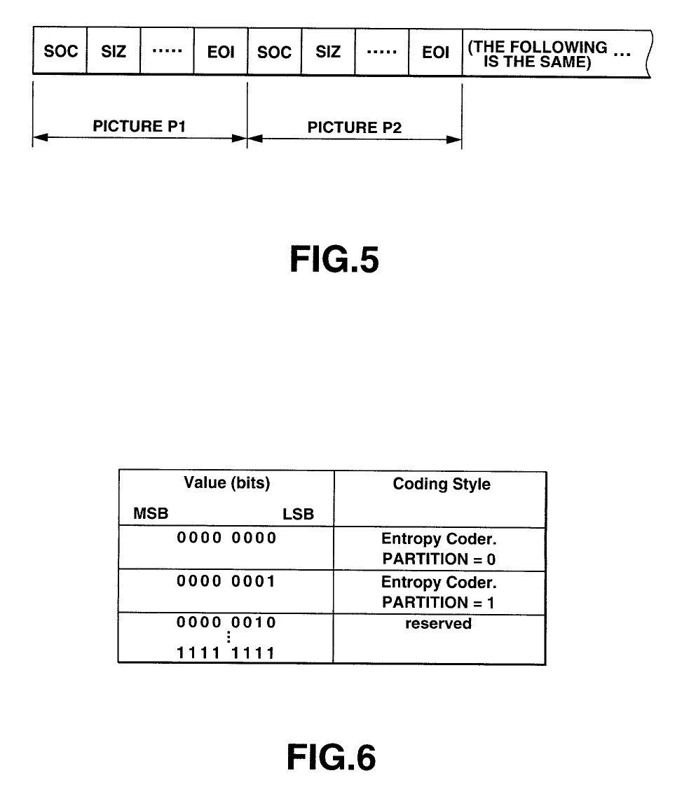

FIG. 5 shows an example of plural consecutive encoded bitstreams of a still picture sequentially coupled to one another. Since one picture begins with SOC and ends in EOI, as shown in FIG. 2, plural pictures are connected to one another into an array of pictures, such as pictures P1, P2, . . . . In the present embodiment, attention is directed to the code SIZ next following the SOC, and vacant bits in this SIZ are exploited to embed the encoding information of moving pictures or a still picture by taking advantage of vacant bits in the SIZ. This embedding technique is hereinafter explained specifically.

According to the draft of the JPEG2000 standard, prepared by the Committee, the SIZ has the function of stating the horizontal and vertical sizes etc of the original picture or tile. In these, several parameters are defined. In the present embodiment, the necessary information is embedded in the parameters Rsiz (Denotes capabilities of the Codestream) or CSsiz (Multiple component transformation used). Specifically, since the parameters Rsiz and CSsiz are partially defined, undefined portions can be used. In the parameter Rsiz, only “0000 0000 0000 0000” is defined (Capabilities specified in the Recommendation/International Standard only), with the other codes (“0000 0000 0000 0001” to “1111 1111 1111 1111”) being vacant or undefined. Therefore, by using these portions, it is possible to embed the aforementioned picture information, encoding picture rate and the frame-field encoding mode information for the case of the picture being an interlaced picture. In the parameter CSsiz, only “0000 0000” is defined (No multiple component transform specified. (A multiple component transform may be specified by the file format level.)), with the remaining codes (“0000 0001” to “1111 1111”) being vacant or undefined.

For example, if the totality of undefined 16 bits of the aforementioned parameter Rsiz are used for description of the picture number, 2¹⁶−1=65,535 pictures may be represented. This indicates that, in a system for displaying 30 pictures per second, display for about 36 odd minutes is possible. It is noted that, if the encoding picture rate or the display picture rate, such as 30 pictures per second, is already known, a surplus value obtained on dividing the original picture number by the value of the display picture rate, herein a value from 0 to 29, can be discriminated on the side decoder (receiver) by detecting the SOC (Start of codestream) of FIG. 2 and by sequentially counting the number of pictures. So, an integer value obtained on dividing the original picture number by the value of the display picture rate can be used as a new picture number. The integer value obtained on dividing the original picture number by the value of the display picture rate for a 135th picture is 4 because 135/30=4.5. Therefore, if 16 bits (undefined portion) of the aforementioned parameter Rsiz are allocated to the integer value obtained on this division, display for substantially 30 times the above-mentioned display time, that is 1,092 minutes (18 odd hours), is possible.

In the parameter CSsiz, the codes other than “0000 0000”, namely the codes “0000 0001” to “1111 1111” are free or undefined, so that, even though the parameter CSsiz is of a shorter bit length than the parameter Rsiz, it is sufficiently possible to embed the encoding picture rate and the frame/field encoding mode information for the case of the picture being an interlaced picture. For example, the picture rate and the frame/field encoding mode information, such as frame (10) and field (11), may be represented by 6 MSB side bits and 2 LSB side bits.

### Second Embodiment

A second embodiment of the present invention is now explained. In this second embodiment, if the number of pictures in an input picture is known from the outset, this number of pictures is embedded in vacant bits of the aforementioned parameters Rsiz or CSsiz in the SIZ parameter of the syntax of the JPEG2000 standard. This is relevant in particular to means for encoding plural pictures and is effective when the number of pictures to be encoded is known at the outset, such as video clip, time-set television program, digital map or consecutive pictures for medical use.

Specifically, the number of pictures now to be encoded is embedded in vacant bits of the aforementioned parameters Rsiz or CSsiz in the SIZ parameter to be appended to an initial encoded picture.

It may be envisaged to encode the pictures in a skipping fashion, without encoding to total number of pictures owned by the original picture. In such case, it may be the number of pictures following thinning that are embedded. The number of pictures following thinning may be embedded as the number of pictures to be now embedded.

If encoding is made following the thinning as described above, data pertinent to the encoding picture rate in such case may be embedded by means shown in connection with the first embodiment to reproduce a picture at a picture rate of the original pictures readily on the side decoder.

### Third Embodiment

This third embodiment relates to one of implementing means in effectuating tile based encoding characteristic of the encoding which is based on the JPEG2000 standard. Thus, in splitting an interlaced picture into plural tiles and in encoding a picture in each tile based on the JPEG2000 standard, from one tile to another, the frame/field encoding information is embedded in vacant bits of codes in the COD parameter in the tile header. Moreover, the frame/field encoding mode information is embedded in vacant bits of the codes in the COD parameter in the tile header. The third embodiment, in which a picture is split into plural tiles to effect encoding from one tile to another, has a merit on the side encoder that it permits parallel processing and saving in the memory space, while having a merit on the side decoder that it permits random accessing and saving in memory space.

Moreover, since picture properties, such as large or small motion or degree of texture fineness, differ from one tile to another, optimum encoding control from one tile to another contributes to improved overall picture quality. In particular, if it is an interlaced picture that is to be encoded, pictures of the even and odd fields differ significantly from each other if a picture of an object undergoes significant motion thus leading to encoded results suffering visual deterioration.

In order to overcome this deficiency, the present embodiment uses means for embedding the frame/field encoding mode information, from tile to tile, by taking advantage of the vacant bits in the header associated with a given tile. Specifically, attention is directed to the COD in the Tile-part header shown in FIG. 4.

The parameter COD, an abbreviation of the Coding style default, means a code stating detailed encoding conditions, such as the number of wavelet splitting levels, progression style, or types of the wavelet filters. Of a number of codes, into which the parameter COD is divided, the codes Scod, having an 8-bit length, allocated thereto, is used.

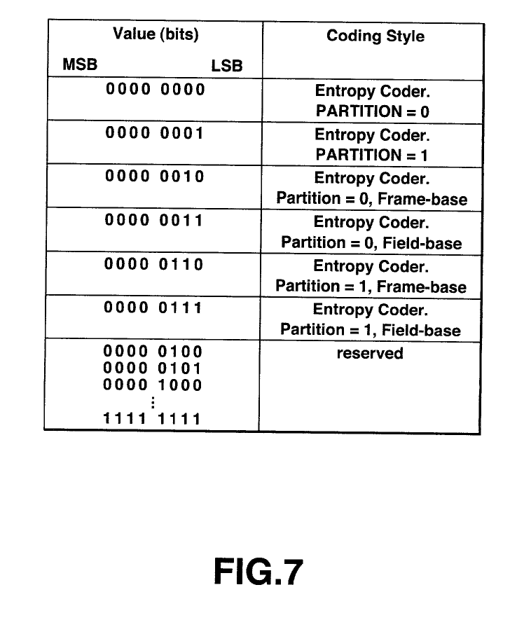

FIG. 6 shows a table indicating the codes Scod of the parameter COD, defined in the Committee draft (CD) of the JPEG2000 standard, while FIG. 7 shows a typical table implemented in the present embodiment.

That is, if the 8-bit code Scod is “0000 0000” or “0000 0001”, the entropy encoding of a pattern 0 and an entropy encoding of a pattern 1 are already defined, respectively. However, the other 8-bit codes are undefined. Therefore, the 8-bit codes Scod of “0000 0010”, “0000 0011”, “0000 0110” and “0000 0111” may be defined as being the partition 0 frame base, partition 0 field base, partition 1 frame base and the partition 1 field base, respectively.

It is possible in this manner to embed whether a given tile, of which the tile part (Tile-part) is a part, has been encoded on the frame base, meaning that odd and even fields have been encoded together, or on the field base, meaning that odd and even fields have been encoded separately, by the use of vacant bits of the code Scod representing the encoding condition for the component. Meanwhile, the partition denotes whether or not partition in the entropy encoding is to be made.

In the present embodiment, the vacant bits of the code Scod in the parameter COD are used. Similar effects may, of course, be achieved using vacant bits of the other codes.

### Fourth Embodiment

A fourth embodiment of the present invention is now explained. In this fourth embodiment, a Signature Box, among various boxes specifying the structure of a file format prescribed in the JPEG2000 standard, is changed to a signature box for Motion-JPEG2000 standard. This embodiment includes one of the boxes for the total number of pictures for encoding, the encoding picture rate and the frame/field encoding mode information for the case of the picture being an interlaced picture. For plural consecutive pictures, picture numbers are appended to the picture-based encoded bitstreams.

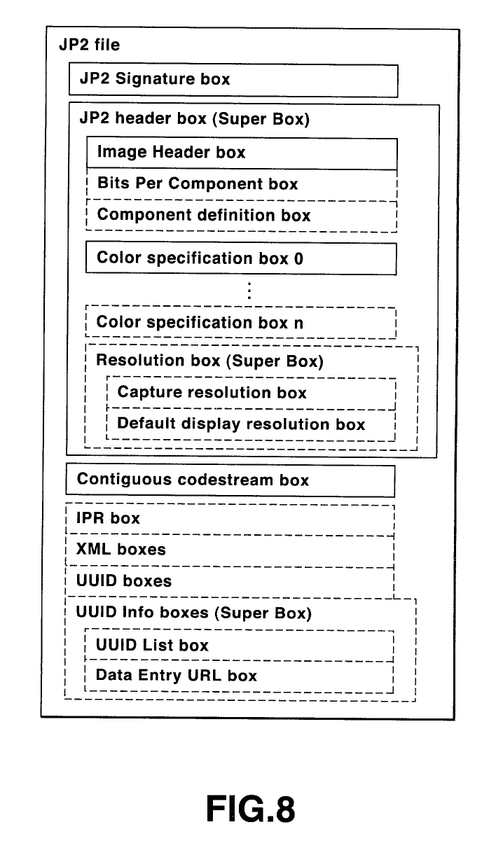

FIG. 8 shows a structure of a file format (File Format) defined in the Committee draft (CD) of the JPEG2000 standard. In the following, the contents of major boxes are explained briefly.

The “JP2 Signature Box” of FIG. 8 has the function of discriminating the “JP2” as a file extension of the JPEG2000 standard. The “JP2 Header Box” is one of the super boxes comprehending several Sub-boxes therein, and has the function of stating the general information, such as samples, color space or resolution. The “Image Header Box” is a box comprehended in the “JP2 Header Box” and has the function of stating the general information, such as picture size or the number of components. The “Color specification box” has the function of stating the means for representing the color space of a decoded picture, such as a standard or the color information.

The “Continuous codestream box” comprehends encoded bitstreams of the JPEG2000 standard. The “UUID Info boxes”, representing super boxes, may be enumerated by “UUID list box” comprehending the UUID list information, and “Data Entry URL box” used for expansion.

In the present embodiment, a file format (File Format) for consecutive moving pictures or still pictures is constructed to inherit the features of the file format of the JPEG2000 standard having the above boxes.

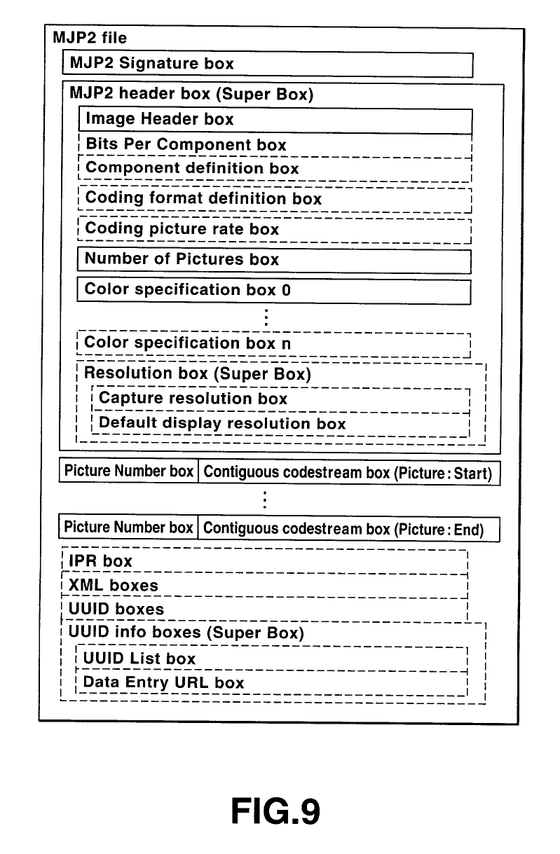

A specified example of the file format of the present embodiment is shown in FIG. 9. The following explanation is centered about the difference from the file format (File Format) of the pre-existing JPEG2000 standard of FIG. 8.

(1) The “MJP2 Signature box” is a box for discriminating an extension “MJP2” of the encoded bitstream file of the Motion-JPEG2000 standard.

(2) The “MJP2 header box” is a super box comprehending the general information pertinent to a picture and comprehends many other boxes.

(3) The “Coding format definition box” has three adaptive modes, that is a frame based, field based and tile based modes. The former two modes execute the encoding based on the full picture frame or field, whereas the third mode uses means for tile-based switching. This case (3) has already been explained in connection with the third embodiment described above. This box is optional because a photographic picture is devoid of interlaced or progressive picture concepts proper to video and hence is deemed to be optional.

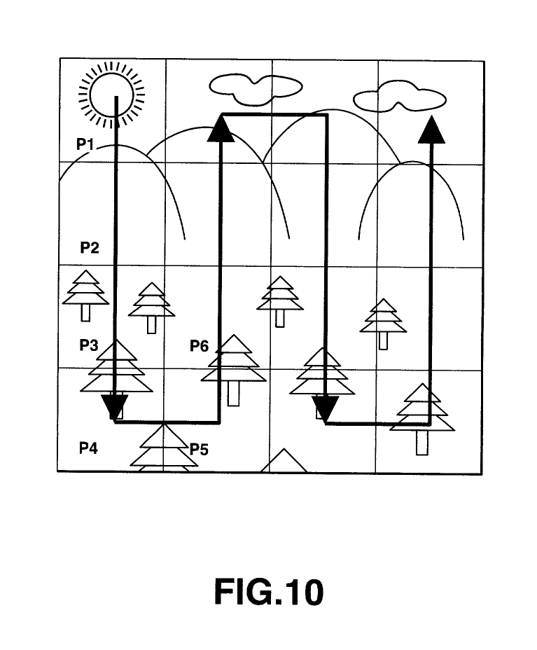

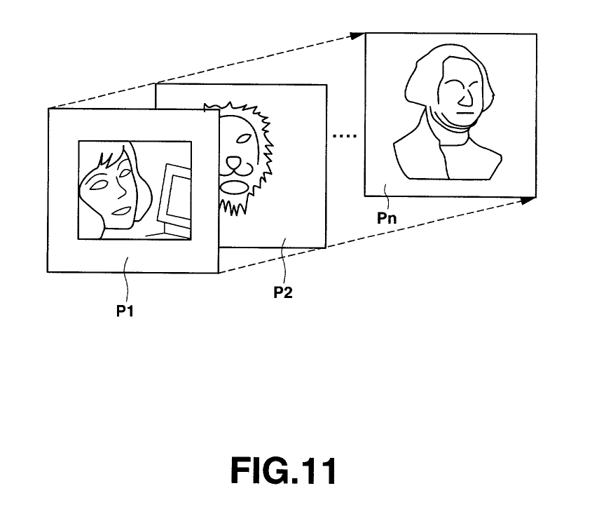

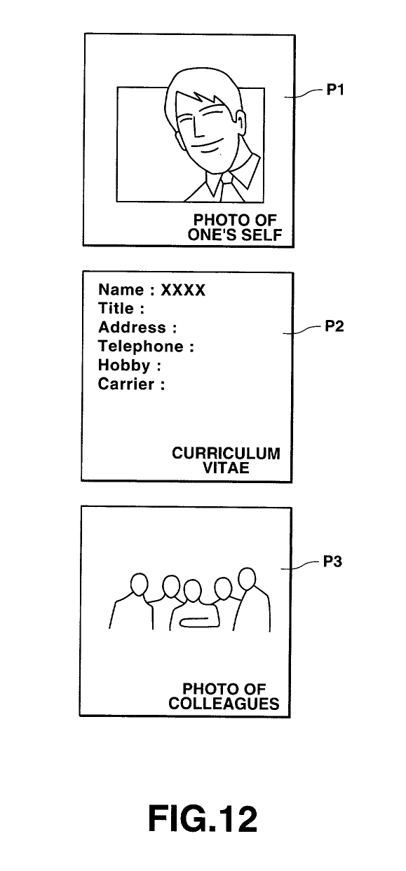

(4) The “Coding picture rate” is a box indicating an encoded picture rate. If, in the case of a video picture, an original picture at a rate of 30 Hz, that is 30 pictures per second, may be at a rate of 10 or 15 Hz due to thinning such as picture skipping. Although this box is optional, it should be noted that, in applications and products, such as digital mapping shown in FIG. 10, a slide show, shown in FIG. 11, a personal information database, shown in FIG. 12, or consecutive photographic pictures of particular sites, such as pictures of pathologic lesion sites, as typical application of the present embodiment, there is no fixed picture rate such as is provided in video. The “Coding picture rate” is optional in order to take these applications into account.

FIG. 10 shows a typical application of digital mapping, wherein a sole large picture is formed by plural pictures P1, P2, . . . . FIG. 11 shows a typical application to a slide show employing plural, for example, n pictures P1, P2, . . . , Pn which are relevant to one another. FIG. 12 shows a typical application to a personal database made up of different data of the personal information, such as photo of a user P1, a curriculum vitac P2, a photo of a colleague P3 and so forth.

(5) The “Number of Pictures box” is a box stating the number of encoded pictures comprehended by an electrolytic solution file of the Motion-JPEG2000 standard.

(6) The “Picture Number box” is a box indicating which number picture as counted from the beginning end is a picture under consideration. This box is followed by “Continuous Codestream box” comprehending the video or audio encoded bitstream. In the structure of FIG. 9, one Continuous Codestream box” necessarily connects to one “Picture Number box”. This is useful in realizing a random access function of reading out and decoding only an encoded bitstream of a specified picture number from the “MJP2” file.

As described above, the signal processing method, the picture encoding apparatus and the picture decoding apparatus according to the present invention can readily be applied to a variety of applications, employing consecutive pictures of moving and still pictures, such as codec, video movie, portable and mobile picture transmission/reception terminals (PDA), compression and decompression units for high definition pictures, such as satellite pictures or pictures for medical use, digital mapping, slide show, database or software modules thereof.

The present invention may, of course, be modified in a range not departing from the scope of the invention, without being limited to the above-described specified embodiments.

What is claimed is:

1. A signal processing method comprising:
a picture inputting step of inputting one or more pictures;
an encoding step of encoding said pictures in accordance with a pre-set encoding standard from one picture to another;
a step of sequentially coupling picture-based encoded bitstreams;
a code appending step of appending a variety of codes for implementing a syntax prescribed in said encoding standard to said encoded bitstreams; and
an embedding step of embedding at least one of the picture number required in encoding the plural pictures, encoding picture rate, and the frame/field encoding mode information, for the case of said picture being an interlaced picture, in vacant bits of said prescribed codes.

2. The signal processing method according to claim 1 wherein said encoding standard is the JPEG2000 standard.

3. The signal processing method according to claim 1 wherein, if said picture number is embedded, said embedding step embeds an integer, obtained on dividing the original picture number by the value of the display picture rate, as the picture number.

4. The signal processing method according to claim 2 wherein said embedding step embeds at least one of the picture number, encoding picture rate and the frame/field encoding mode information in vacant bits of Rsiz or CSsiz of SIZ parameters in the syntax of the JPEG2000 standard.

5. The signal processing method according to claim 2 wherein, if the number of the input picture is known at the outset, said embedding step embeds the number of pictures, picture number or the picture number following thinning in vacant bits in Rsiz or CSsiz of the SIZ parameter in the syntax of the JPEG2000 standard.

6. The signal processing method according to claim 2 wherein, if an interlaced picture is split into a plurality of tiles and pictures in said tiles are encoded in accordance with the JPEG2000 standard form one tile to another, said embedding step embeds the frame/field encoding mode information, from one tile to another, by taking advantage of vacant bits in a header associated with each tile.

7. The signal processing method according to claim 2 wherein said embedding step embeds said frame/field encoding mode information in vacant bits of codes in a COD parameter in a tile header.

8. A signal processing apparatus comprising:
picture inputting means for inputting one or more pictures;
encoding means for encoding the pictures in accordance with a pre-set encoding standard from one picture to another;
means for sequentially coupling picture-based encoded bitstreams, appending a variety of codes for implementing a syntax prescribed in said encoding standard to said encoded bitstreams and for embedding at least one of the picture number required in encoding the plural pictures, encoding picture rate, and the frame/field encoding mode information, for the case of said picture being an interlaced picture in vacant bits of said prescribed codes.

9. The signal processing apparatus according to claim 8 wherein said encoding standard is the JPEG2000 standard.

10. The signal processing apparatus according to claim 8 wherein, if said picture number is embedded, said output bitstream generating means embeds a value, obtained on dividing the original picture number by the value of the display picture rate.

11. The signal processing apparatus according to claim 9 wherein said output bitstream generating means embeds at least one of the picture number, encoding picture rate and the frame/field encoding mode information in vacant bits of Rsiz or CSsiz of SIZ parameters in the syntax of the JPEG2000 standard.

12. The signal processing apparatus according to claim 9 wherein, if the number of the input picture is known at the outset, said output bitstream generating means embeds the number of pictures, picture number or the picture number following thinning in vacant bits in Rsiz or CSsiz of the SIZ parameter in the syntax of the JPEG2000 standard.

13. The signal processing apparatus according to claim 9 wherein, if an interlaced picture is split into a plurality of tiles and pictures in said tiles are encoded in accordance with the JPEG2000 standard form one tile to another, said output bitstream generating means embeds the frame/field encoding mode information, from one tile to another, in vacant bits in a header associated with each tile.

14. The signal processing apparatus according to claim 9 wherein said output bitstream generating means embeds said frame/field encoding mode information in vacant bits of codes in a COD parameter in a tile header.

15. A signal processing method comprising:
a step of being fed with an output bitstream, said output bitstream being a bitstream obtained on encoding input pictures in accordance with a pre-set encoding standard per picture of said input pictures, said bitstream obtained on encoding input pictures having embedded in a header part thereof a variety of codes for realizing a syntax prescribed in said encoding standard and an integer value obtained on dividing an original picture number by a value of the display picture rate, and deciphering the codes in said header part of said output bitstream to detect a number from 0 to said value of the display picture rate;
a step of multiplying an integer obtained on dividing said original picture number by the value of the display picture rate with the value of the display picture rate; and
a step of computing an ultimate picture number from the multiplied result and the detected number.

16. A signal processing apparatus comprising:
means for being fed with an output bitstream, said output bitstream being a bitstream obtained on encoding input pictures in accordance with a pre-set encoding standard per picture of said input pictures, said bitstream obtained on encoding input pictures having embedded in a header part thereof an integer value obtained on dividing an original picture number by a value of the display picture rate, along with a variety of codes for realizing a syntax prescribed in said encoding standard, and for deciphering the codes in said header part of said output bitstream to detect a number from 0 to said value of the display picture rate;
means for multiplying an integer obtained on dividing said original picture number by the value of the display picture rate with the value of the display picture rate; and
means for computing an ultimate picture number from the multiplied result and the detected number.

17. A signal processing method comprising:
a step of being fed with an output bitstream, said output bitstream being a bitstream obtained on encoding input pictures in accordance with a JPEG2000 standard per picture of said input pictures, said bitstream obtained on encoding input pictures having embedded in a header part thereof an integer value obtained on dividing an original picture number by a value of the display picture rate, along with a variety of codes for realizing a syntax prescribed in said JPEG2000 standard, and for deciphering the codes in said header part of said output bitstream to detect a number from 0 to said value of the display picture rate;
a step of changing a Signature box, as one of boxes of a file format prescribed in said JPEG2000 standard, into a Signature box extended for moving pictures; and
a step of adding a picture number to a picture-based encoded bitstream for continuous plural pictures, there being provided one of the total number of encoded pictures, encoding picture rate, and the Box of the frame/field encoding mode information for the case of the picture being an interlaced picture, as said variable codes.
